(19) United States
(12) Patent Application Publication
(10) Pub. No.: US 2016/0243961 A1
(43) Pub. Date: Aug. 25, 2016

(54) Energy Storage System for an Electrically Driven Vehicle

(71) Applicant: Bayerische Motoren Werke Aktiengesellschaft, Muenchen (DE)

(72) Inventor: Andre SCHMITZ, Muenchen (DE)

(21) Appl. No.: 15/146,972

(22) Filed: May 5, 2016

Related U.S. Application Data
(63) Continuation of application No. PCT/EP2014/072391, filed on Oct. 20, 2014.

(30) Foreign Application Priority Data
Nov. 7, 2013 (DE) 10 2013 222 641.1

(51) Int. Cl. B60L 15/00; H02P 27/06; B60L 11/18

(52) U.S. Cl. CPC B60L 15/007; B60L 11/1803; B60L 11/1868; H02P 27/06

(57) ABSTRACT

An energy storage system is provided for an electrically driven vehicle, having a first energy storage unit which provides sufficient basic electric power to operate at least one electric motor of the vehicle. The first energy storage unit is connected to the electric motor of the vehicle via an inverter. A connection is provided via which at least one additional energy storage unit can be connected parallel to the first energy storage unit. In another variant, an energy storage system for an electrically driven vehicle has three energy storage units, each of which has at least one energy store. The three energy storage units are connected such that each energy storage unit provides one phase of a three-phase alternating current for an electric motor of the vehicle. The individual energy storage units can be expanded by adding additional energy stores.

### CROSS REFERENCE TO RELATED APPLICATIONS

This application is a continuation of PCT International Application No. PCT/EP2014/072391, filed Oct. 20, 2014, which claims priority under 35 U.S.C. §119 from German Patent Application No. 10 2013 222 641.1, filed Nov. 7, 2013, the entire disclosures of which are herein expressly incorporated by reference.

### BACKGROUND AND SUMMARY OF THE INVENTION

The invention relates to an energy storage system for an electrically driven vehicle.

In electrically driven vehicles, both in PHEV (plug-in hybrid) vehicles as well as in the case of purely electrically operated vehicles (BEV), an energy storage unit which is composed of one or more individual battery cells as energy stores serves as an energy source at present. The battery cells are usually individual lithium ion cells. These are connected to one another in series or in a combination of serial and parallel connections. The total and type of the connections of the battery cells determine the available energy and therefore the range of an electrically operated vehicle. A specific energy storage unit always supplies a predetermined maximum current strength here in a predetermined voltage range, said current strength depending on the type and design of the energy storage unit and being invariable. Therefore, the power of the electrically driven vehicle is also defined simultaneously by the energy storage unit used, since the energy storage unit is characterized by a fixed ratio of power to energy.

This brings about a situation in which it is not possible to provide gradations of power in a product range of electrically driven series-produced vehicles, as is known from vehicles with internal combustion engines where different engines are used in a vehicle model which is otherwise largely unchanged. For the consumer, this selection has constituted an important purchasing decision in the past.

The object of the invention is to easily differentiate electrically driven vehicles in terms of the vehicle power level.

According to the invention, this and other objects are achieved with a first embodiment of an energy storage system for an electrically driven vehicle which has a first energy storage unit which makes available sufficient basic power to operate at least one electric motor of the vehicle, and which is connected to an electric motor of the vehicle via an inverter, wherein a connection is provided via which at least one further energy storage unit can be connected parallel to the first energy storage unit. If only the first energy storage unit is used, the vehicle has power which corresponds to basic power in the product range. However, it is easily possible to increase the power of the vehicle by connecting one or more further energy storage units. In this way, a modular design can be achieved in which, given a vehicle which is intended to have increased power, one or more further energy storage units are easily connected to the connection which is provided in each vehicle, without changes having to be made to the basic configuration of the electrically driven vehicle.

In one preferred embodiment, at least one second energy storage unit is provided which makes available additional power for operating an electric motor of the vehicle, and which is connected parallel to the first energy storage unit, preferably by connecting it to the connection of the energy storage system. As a result of the parallel connection, the total power of the vehicle can easily be increased.

The second energy storage unit can be connected parallel to the first energy storage unit, for example via a DC/DC converter.

The DC/DC converter serves as a coupling element and can be configured as a bidirectional step-up converter, step-down converter or step-up/step-down converter as required. In this context it is irrelevant on which of the energy storage units the DC/DC converter is located.

Each of the energy storage units contains one or more energy stores which are each composed of a multiplicity of individual battery cells which are connected in series and/or parallel. It is also possible to use battery cells of any desired type, for example lithium-ion cells, metal hydride cells or metal air cells, but also hybrid capacitors, double-layer capacitors or pseudo-capacitors. Likewise, one of the energy storage units can be a fuel cell stack or a plurality of fuel cell stacks which are connected electrically to one another.

The inverter, which generates the alternating current which is necessary for operating the electric motor from the direct current which is supplied by the energy storage units is arranged, for example, between the connection point of the energy storage units, which is formed, in particular, by the connection of the energy storage system, and the electric motor.

In this context, a common inverter can be connected downstream of the two energy storage units.

However, it is also possible to assign a separate inverter to each of the energy storage units. In this case, as many inverters as energy storage units are provided.

The two energy storage units can be connected here to the same electric motor or else to different electric motors of the vehicle.

The object is also achieved with an energy storage system for an electrically driven vehicle according to a further embodiment, in which energy storage system three energy storage units are provided which each have at least one energy store, wherein the three energy storage units are connected in such a way that each makes available a phase of a three-phase alternating current for an electric motor of the vehicle. The energy stores may be, for example, individual battery cells, but also already prefabricated units composed of a plurality of battery cells.

This energy storage system can also easily be configured for different vehicle power levels in that at least one of the energy storage units has a connection for connecting further energy stores.

In order to extend the energy storage system, further energy stores can be added to the individual energy storage units. In such a case, at least one of the energy storage units has more than two energy stores. It is possible, for example, for three energy stores to be connected in series per energy storage unit. However, it is also possible to use only two or significantly more than three energy stores.

All of the energy stores of the respective energy storage unit are connected, for example, in series with one another via inverters.

Each energy store in one of the energy storage units can be operated in three different modes. The energy store can increase the output voltage of the energy storage unit by its output voltage, remain without effect on the voltage of the energy storage unit or reduce the output voltage of the respective energy storage unit by its output voltage.

The invention makes available a kit system for electrically driven vehicles, which kit system permits the electrically driven vehicle to be differentiated with respect to power without large structural changes. In order to be able to implement different power levels in a vehicle model of an electrically driven vehicle, according to the invention the energy storage system is configured in such a way that at least one energy storage unit is provided which makes available the basic power to operate the vehicle. In order to provide a vehicle with relatively high power, in one embodiment a complete second energy storage unit is added. In another embodiment, energy storage units of the basic model are expanded by adding individual energy stores.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of an energy storage system according according to a first embodiment of the invention;

FIG. 2 is a schematic illustration of an energy storage system according according to a second embodiment of the invention; and

FIG. 3 is a schematic illustration of an energy storage system according according to a third embodiment of the invention.

### DETAILED DESCRIPTION OF THE DRAWINGS

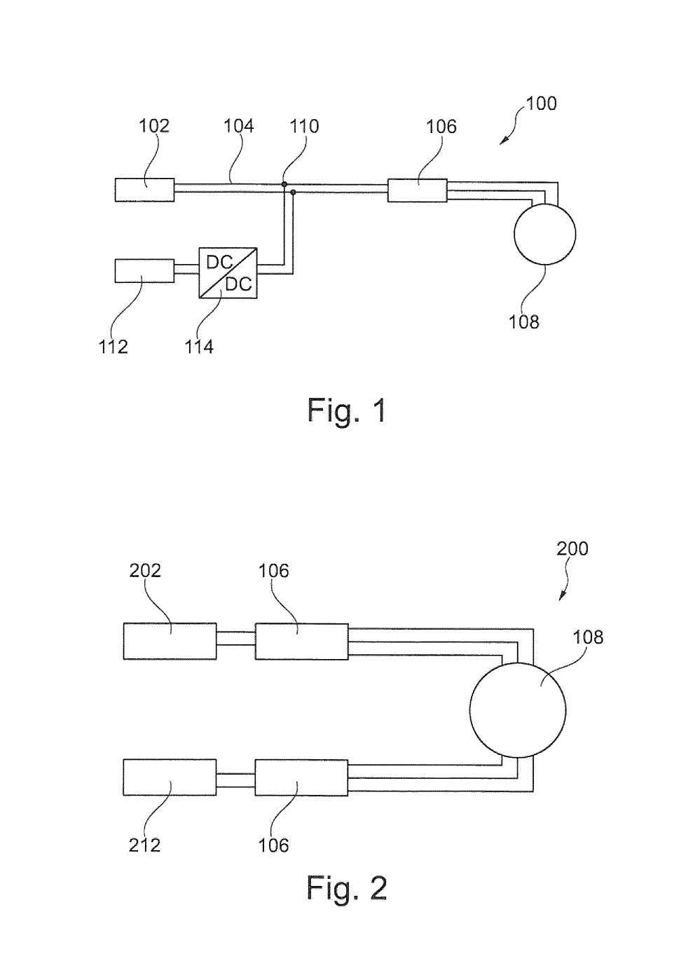

FIG. 1 shows an energy storage system 100 for an electrically driven vehicle (not illustrated in more detail) having a first energy storage unit 102 which is connected via electric leads 104 to an inverter 106 which transforms the direct current supplied by the energy storage unit 102 into a three-phase alternating current and is connected to an electric motor 108 of the vehicle. The first energy storage unit 102 supplies sufficient energy for predefined basic power of the vehicle.

The energy supply of the drive of the vehicle is illustrated here only schematically with reference to the operation of a single electric motor 108. Of course, for example, the energy storage unit 102 could also supply all the electric motors of the vehicle, or a basic model with an energy storage unit 102 could be provided for each electric motor.

A connection 110 is provided between the inverter 106 and the first energy storage unit 102 which is embodied in the form of an electric plug-type connector and to which a second energy storage unit 112 is connected in a parallel connection in the example shown. The coupling of the second energy storage unit 112 to the existing system via the connection 110 is carried out by way of a DC/DC converter 114 which makes available a direct voltage of the desired level.

It would also be possible to assign the DC/DC converter 114 to the first energy storage unit 102. Of course, it is also possible to provide each of the energy storage units 102, 112 with a DC/DC converter 114.

Even more energy storage units may be connected in parallel with the connection 110, preferably then each with their own DC/DC converter, in order to increase further the power of the energy storage system of the vehicle.

FIG. 2 shows a second embodiment of an energy storage system 200. In this case, two energy storage units 202, 212 are provided which are each connected to an inverter 106, 206 and connected thereby to the electric motor 108. In this case, the electric motor 108 has an additional connection which is connected to the inverter 206 of the second energy storage unit 212. It would also be possible to couple the two inverters 106, 206, and therefore the two energy storage units 202, 212, to different electric motors 108.

In both previously described embodiments, in each case the first energy storage unit 102, 202 is dimensioned sufficiently to make available a basic power which is sufficient to operate the electric motor 108. Providing the additional second energy storage unit 112, 212 increases the overall power of the energy storage system 100, 200.

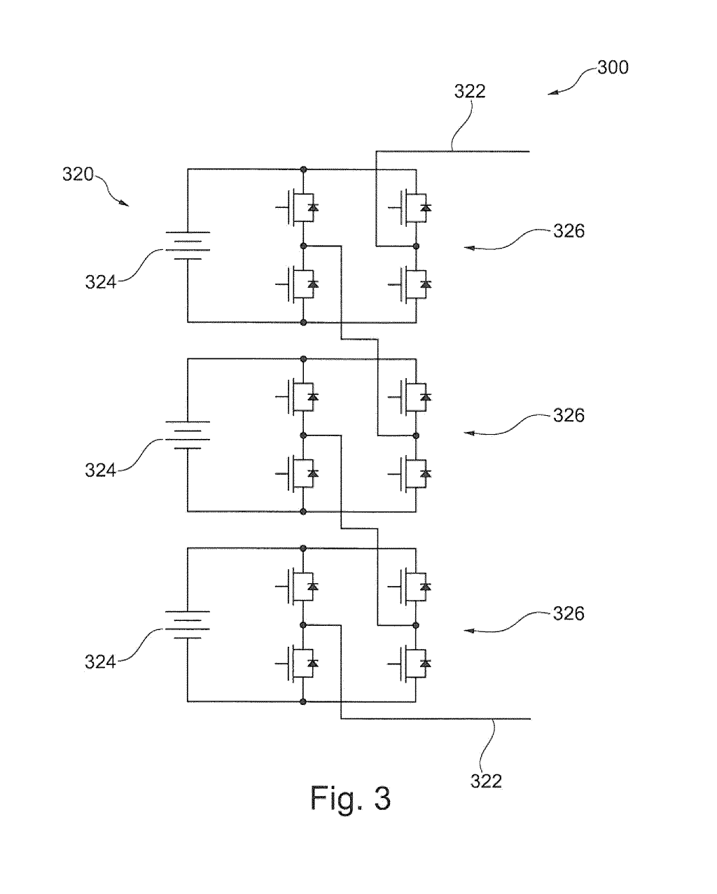

FIG. 3 shows a further embodiment of an energy storage system 300, wherein just one of a total of three energy storage units 320 is illustrated. The three energy storage units 320 are connected by their outputs 322 to an electric motor (not shown here) in such a way that each energy storage unit 320 supplies a phase of a three-phase alternating current.

In this example, each of the energy storage units 320 has three individual energy stores 324. Each of the individual energy stores 324 can be composed of a plurality of individual battery cells which can be connected in any desired suitable way. It is not necessary for all the energy stores 324 to be of the same design.

All the individual energy stores 324 of an energy storage unit 320 are each connected to one another in series via an inverter 326.

If the power of the vehicle is to be increased in such an energy storage system 300, further individual energy stores 324 can easily be added in series with the existing series connection via one inverter in each case. For this purpose, connections (not illustrated) are provided in the respective energy storage unit 320, with the result that further energy stores 324 simply have to be connected via a plug.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An energy storage system for an electrically driven vehicle, comprising:
a first energy storage unit that makes available sufficient basic power to operate at least one electric motor of the vehicle;
an inverter through which the first energy storage unit is connected to the electric motor of the vehicle; and
a connection arranged to provide a parallel connection of at least one further energy storage unit with the first energy storage unit.

2. The energy storage system according to claim 1, further comprising:
a second energy storage unit that makes available additional power to operate the electric motor of the vehicle, wherein the second energy storage unit is connected in parallel with the first energy storage unit via the connection.

3. The energy storage system according to claim 2, further comprising a DC/DC converter through which the second energy storage unit is connected in parallel with the first energy storage unit.

4. The energy storage system according to claim 3, further comprising a common inverter connected downstream of the first and second energy storage units.

5. The energy storage system according to claim 2, further comprising a common inverter connected downstream of the first and second energy storage units.

6. The energy storage system according to claim 2, wherein the first and the second energy storage unit are each assigned a separate inverter via which the respective first and second energy storage units are connected to the electric motor of the vehicle.

7. The energy storage system according to claim 6, wherein the first and second energy storage units are connected to different electric motors of the vehicle.

8. An energy storage system for an electrically driven vehicle, comprising:
three energy storage units, each of the three energy storage units having at least one energy store, wherein
the three energy storage units are connected such that each of the three energy storage units makes available a phase of a three-phase alternating current for an electric motor of the vehicle.

9. The energy storage system according to claim 8, wherein at least one of the three energy storage units has a connection for connecting additional energy stores.

10. The energy storage system according to claim 9, wherein at least one of the three energy storage units comprises more than two energy stores.

11. The energy storage system according to claim 8, wherein at least one of the three energy storage units comprises more than two energy stores.

12. The energy storage system according to claim 10, wherein all of the energy stores of at least one of the three energy storages units are connected in series with one another via inverters.

13. The energy storage system according to claim 11, wherein all of the energy stores of at least one of the three energy storages units are connected in series with one another via inverters.
